(19) United States
(12) Patent Application Publication
(10) Pub. No.: US 2005/0267774 A1
(43) Pub. Date: Dec. 1, 2005

(54) Method and apparatus for obtaining and using vehicle sales price data in performing vehicle valuations

(76) Inventors: David Merritt, Aurora, IL (US); Roy Stokes, Lockport, IL (US); Carlos Navarro, Riverside, IL (US)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 10/858,149

(22) Filed: Jun. 1, 2004

(51) Int. Cl. G06F 17/60

(52) U.S. Cl. 705/1; 705/10

(57) ABSTRACT

A system and method determines a vehicle valuation by obtaining actual vehicle sales price data pertaining to automobile dealer or private individual sales from a local, state or federal government agency, such as a Department of Motor Vehicles (DMV), a Department of Revenue (DOR), an Internal Revenue Service (IRS), etc. and uses this actual sales price data to determine a market value for a particular automobile. The system and method may include determining, from sources other than the government agency, information about a particular comparable vehicle, such as the mileage, the options, the equipment, and the condition of a particular comparable vehicle prior to a sale of the vehicle and then attaching an actual sales price for the particular comparable vehicle as obtained from the government agency after the sale of the particular vehicle to thereby create a comparable vehicle within a database. If desired, the actual sales price data, as obtained from a government agency, may be used in conjunction with or instead of other vehicle pricing data obtained from other sources, such as the list price, an advertised price or a take price to determine a valuation for a particular vehicle.

### TECHNICAL FIELD

The disclosed method and apparatus generally relates to performing vehicle valuations and, in particular, to obtaining actual vehicle sales price data and using such sales price data to perform vehicle valuations, such as those relied upon in the automobile insurance industry.

### DESCRIPTION OF THE RELATED ART

It is typical for insurance companies to insure automobiles in the case of loss or damage due to accidents, theft, acts of nature, etc. As used herein, the term automobile includes vehicles of any nature, such as cars, trucks, pickups, vans, UTVs, SUVs, motorcycles, etc. One aspect of the automobile insurance industry is involved with total loss situations, which arise when the insured or claimant automobile can not be repaired or when the cost of the repairs to the insured or claimant automobile would be close to or greater than the worth of the automobile. Generally speaking, an insurance company first estimates or evaluates the value of a particular vehicle, such as one that has been in an accident, to determine if the vehicle is a total loss. If the vehicle is deemed to be a total loss, the insured or claimant is provided with a payment by the insurer based upon the estimated value of the vehicle in its pre-accident condition. As part of this process, an insurance adjuster typically conducts an appraisal of the vehicle to determine whether it is worth repairing or whether the value of the vehicle is less than the amount of repairs that would be needed to return the vehicle to its pre-accident condition. Of course, as part of this process, it is necessary to determine a reasonable estimate of the actual value of the vehicle immediately prior to the accident or other cause of damage or loss.

Insurance adjusters typically determine an estimate of the reasonable value or worth of a vehicle based on a number of factors including, for example, the year, make and model of the vehicle, the condition of the vehicle prior to the accident, the mileage of the vehicle prior to the accident, the options or equipment on the vehicle, etc. The insurance adjuster may use any of a number of known references to then estimate the value of the vehicle based on these factors. There are, for example, numerous regularly published periodicals or printed references, such as Kelley's Blue Book™, Maclean Hunter's Redbook™, NADA Official Used Car Guide® and NADA Official Older Used Car Guide®, etc. which purport to provide a value for vehicles based on some or all of the factors discussed above. Unfortunately, these periodicals or other printed references are imprecise, are not necessarily based on verifiable data and do not typically value vehicles based on the local geographic market in which the insured or claimant vehicle resides. It is well known, however, that the worth of a vehicle is dependent (i.e., varies) on the local geographic market in which the vehicle resides due to a number of factors such as the local economy, the local weather (which contributes to more or less exposure damage to a car over time), and access and availability to auto dealers.

As a result, the insurance industry and, in particular, insurance companies, have obtained vehicle valuations provided by third party vendors such as CCC Information Services Inc. in determining whether a total loss situation is present and to determine the payment needed to be made to the insured or claimant in the event of a total loss. These vehicle valuations are based on a comprehensive compilation of data collected from numerous sources within the used automobile market and are based on the local market in which the insured or claimant vehicle is located or garaged.

One known system of valuing a vehicle collects data from numerous used automobile sale sources including automobile dealers, printed automobile advertisements, internet sales, etc. and uses this data to determine a local market value for a particular vehicle. In this system, numerous vehicle valuation representatives, called field inventory representatives (FIRs), are employed across the nation to obtain used automobile data from automobile dealers, which is then used in providing an evaluation of a particular vehicle. Typically, the FIRs go to different automobile dealer lots, inspect the used automobiles on the lots and record information on the used automobiles at the lots including for example, the vehicle identification number (VIN) for each automobile, the year, make and model of the each of the automobiles, the mileage of each of the automobiles, the options and equipment that are on each of the automobiles (such as the type of transmission and stereo system, the existence of a sunroof, heated seats, etc.), the list price of each of the automobiles as advertised by the dealer, and some general information on the condition of each of the automobiles, such as if each of the automobiles are clean, have any dents, rust, stains on the carpet, paint chips, scratches, etc. Still further, the FIRs obtain from the automobile dealer what is referred to as a “take price” for each of the observed automobiles. The take price is essentially the price that the dealer would take for the automobile if offered by a customer. Many dealers define the take price in some fixed or predetermined manner, such as a percentage of the list price, a fixed amount off of the list price based on the list price, such as deducting $1500 from the list price if the list price is over $15,000, deducting $1000 if the list price is over $10,000, etc. In any event, the take price reflects the amount for which the dealer would readily sell the automobile if offered by a customer. However, the take price is not necessarily equal to the actual sales price of the automobile, as consumers are routinely able to purchase vehicles at prices lower than the take prices provided by dealers to companies involved with vehicle valuations. Take prices, however, are more reflective of the value of a vehicle than list prices, as list prices usually serve as a starting point for negotiations between the consumer and the dealer and list prices are consistently much higher (i.e., fifteen percent or more on average) than the actual sales price of vehicles sold by dealers.

There is a limited number of automobile dealers in any particular geographic region or area, and thus, there is a limited number of any particular year, make and model of automobile on dealer lots at any particular time. To create a more complete database with which to evaluate the worth of automobiles in a particular geographic region, the dealer data collected by the FIRs is supplemented with automobile sales data from other sources.

In particular, additional automobile valuation data is obtained from automobile sales publications such as newspapers and specialized automobile sales magazines or periodicals. This data maybe collected from classified advertisements or from dealer advertisements within a particular publication and is collected based on the local market in which the automobile is garaged. Generally speaking, the information obtained from the publications include the year, make and model of the automobile, the asking or advertised price for the automobile, the approximate mileage of the automobile and options or equipment data pertaining to the automobile.

Other sources of automobile valuation data includes internet sources, which might include dealer advertisements as well as private advertisements. Here, a database of the standard options for an automobile may be used to populate the options and equipment available on a particular advertised automobile, as well as to estimate an average mileage for the automobile if no mileage is provided.

Based on the information collected by the FIRs and the information collected from the various publications about comparable vehicles, a valuation of the insured or claimant vehicle is then made by comparing the insured or claimant vehicle to the comparable vehicles stored within the database. This step includes collecting data about the insured or claimant vehicle, including the year, make and model of the insured or claimant vehicle, the mileage of the insured or claimant vehicle prior to the accident, the condition of the insured or claimant vehicle, such as whether the insured or claimant vehicle is in below average, average, above average, or exceptional condition, the options and equipment on the insured or claimant vehicle and the local market of the insured or claimant vehicle, such as the zip code in which the insured or claimant vehicle resides. Next, the comparison vehicle data stored in the database is filtered to obtain a set of comparable automobiles that are to be used to value the insured or claimant vehicle. The database can be searched and filtered based on the year, make and model of the insured or claimant vehicle and the local geographic region of the insured or claimant vehicle. After identifying the set of comparable automobiles stored in the database, each of the comparable automobiles is adjusted based on the differences between the comparable automobiles and the insured or claimant vehicle. Thus, the value of the comparable automobiles may be adjusted up or down to account for the difference between the mileage of the comparable automobile and the insured or claimant vehicle, the difference between the condition of the comparable automobile and the insured or claimant vehicle, the difference between the options or equipment on the comparable automobile and on the insured or claimant vehicle, etc. If necessary, adjustments may also be made based on differences in the year of the comparable automobile and the insured or claimant vehicle, the model, body type or engine of the comparable automobile and the insured or claimant vehicle, etc. Once these adjustments are made, the value of the loss vehicle is determined by averaging the adjusted values of the comparable automobiles. That value is then provided to the insurance company.

The insurance company uses the value of the insured's or claimant's automobile to determine if the loss vehicle should be declared a total loss and if so what amount of money is due to the insured or claimant. Typically speaking, the insurance company pays a fee, such as a per use fee, for obtaining the valuation of an automobile from the third party vendor that provides the above-described system.

As will be apparent, the system described above does not use actual automobile sales prices in valuing the comparable automobiles but, instead, uses a dealer list price, a take price or an advertised price, such as the price advertised in the magazine, newspaper, internet, etc. The reason that actual sales prices have not been used is that actual sales price data is difficult if not impossible to obtain either from the purchasers or the sellers of the comparable automobiles. In many cases, the purchaser of a particular comparable automobile is unknown, cannot be determined from, or is not made available by the dealer or the advertisement and, in any event, the purchaser is unlikely to disclose what the purchaser actually paid for an automobile after the sale is complete. Likewise, private sellers are unlikely to disclose to a third party the actual negotiated sales price of an automobile. Still further, even if private sellers or purchasers are amenable to disclosing the actual sales price of the automobile after the sale is commenced, there is no reliable way to verify this data. Furthermore, it has been impossible to collect actual sales price data from automobile dealers. In particular, most dealers generally refuse to provide actual sales price data to third parties as the dealers consider this data to be confidential and proprietary.

Recently, however, the California state legislature has proposed an insurance regulation which would prevent the use of the so-called take price in performing automobile valuations for insurance purposes. Instead, this proposed regulation requires the use of either actual sales prices or the list (advertised) prices when determining the value of a comparable automobile. Because actual dealer sales price data is not readily available from the dealers, this regulation would defacto require the use of the dealer list price which, as indicated above, is known to be traditionally much higher than the actual sales price for which the dealer sells the automobile. This scenario would thereby lead to inaccurately inflated automobile valuations, which would ultimately lead to increased insurance rates.

### SUMMARY

It has been determined by the inventors hereof that automobile dealers and private parties, while not generally willing or able to provide actual automobile sales price data to private third parties, must at least in some states provide both new and used automobile sales price data to government agencies for taxing and regulation purposes. For example, California automobile dealers and private parties must provide the actual sales prices for automobiles that these persons and entities have sold to the California DMV for taxing and regulatory purposes. The inventors hereof have also determined that this sales price data, while not being available directly from the dealers or private parties themselves, can be obtained from the government agency by a third party if proper channels are followed and the proper requests are submitted. The inventors hereof have also determined that this actual sales price data, once collected, can be used as actual verifiable sales price data for determining valuations for insured or claimant vehicles.

To that effect, a system and method is described herein which determines a vehicle valuation by obtaining actual vehicle sales price data pertaining to automobile sales by dealers and private parties from a local, state or federal government agency, such as a Department of Motor Vehicles (DMV), Department of Revenue (DOR), an Internal Revenue Service (IRS), etc. and uses this actual sales price data to determine a market value for a particular automobile, such as an insured or claimant automobile. The system and method may include determining, from sources other than the government agency, information about a particular comparable vehicle, such as the mileage, the options, the equipment, the condition, etc. of a particular comparable vehicle prior to a sale of the vehicle. The system and method may then attach, to the previously collected information about the particular vehicle, an actual sales price for the particular comparable vehicle as obtained from the government agency after the sale of the particular vehicle, to thereby create a comparable vehicle within a database. If desired, the actual sales price data, as obtained from a government agency, may be used in conjunction with or instead of other vehicle pricing data obtained from other sources, such as a list or advertised price, a take price, etc., to determine a valuation for a particular vehicle.

The use of actual vehicle sales price data as reported to and obtained from a government agency has the benefit of being more accurate with respect to the value of an actual vehicle used as a comparable vehicle in automobile valuations, as the sales price reflects an actual market value at which a seller is willing to sell and a buyer is willing to buy that vehicle. Still further, because automobile dealers and private parties must report this information to the government agency for taxing and regulatory purposes, this data is more likely to be accurate and reliable, as there are typically high penalties for misreporting sales price information to the government, including both criminal and civil penalties. Additionally, this sales price data may be verified by other parties, such as insurance regulatory agencies which traditionally oversee the insurance companies that rely on or use the vehicle valuations produced using this data.

### BRIEF DESCRIPTION OF THE DRAWINGS

FIG. 1 is a block diagram of a computer system that may be used to generate a vehicle valuation based on actual vehicle sales prices collected from a government agency;

FIG. 2 is flow chart of a method that may be used to obtain actual vehicle sales price data and to generate vehicle valuations based on the collected actual vehicle sales price data;

FIG. 3 is a vehicle valuation report that may be generated by the computer system of FIG. 1 to list specifics associated with a loss vehicle for which a valuation is being created and the valuation of that vehicle based on a set of comparable vehicles;

FIG. 4 is a report that may be generated by the computer system of FIG. 1, defining an example local market and the number and type of comparison vehicles used to determine a valuation for the loss vehicle;

FIG. 5 is a report that may be generated by the computer system of FIG. 1, illustrating a set of dealer-based comparison vehicles and the manner in which the values of the comparison vehicles are adjusted based on conditions and options associated with the loss vehicle;

FIGS. 6A and 6B are a report that may be generated by the computer system of FIG. 1, listing a complete set of advertised and dealer-based comparison vehicles and the manner in which the values of the comparison vehicles were adjusted based on conditions and options associated with the loss vehicle;

FIG. 7 is a report that may be generated by the computer system of FIG. 1, illustrating a summary of the comparison vehicles used in the valuation of the loss vehicle, along with the weighting given to each of the comparison vehicles in the valuation of the loss vehicle; and

FIG. 8 is a report that may be generated by the computer system of FIG. 1, illustrating adjustments made to the loss vehicle based on an inspection of the loss vehicle by, for example, an insurance adjuster.

### DETAILED DESCRIPTION

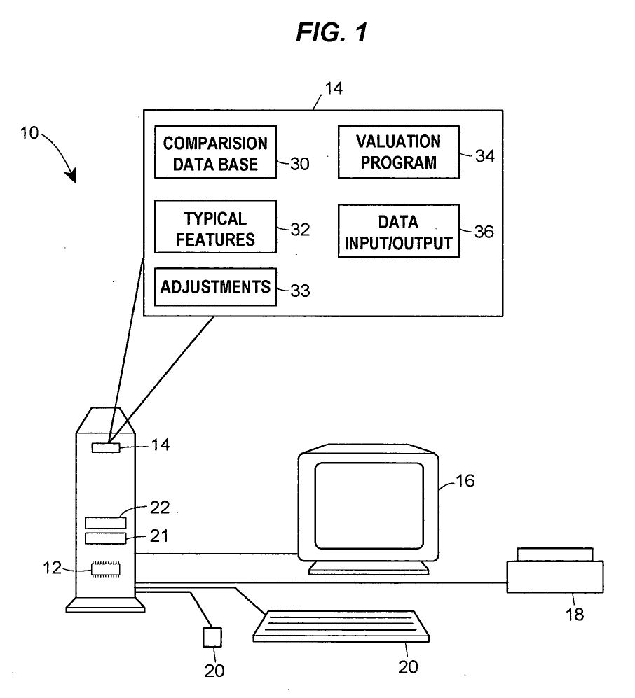

Referring now to FIG. 1, a computer system 10 which may implement or execute a vehicle valuation system includes a processor 12 (such as a general purpose processor), a memory 14, a display screen 16 (such as a CRT screen, an LCD or plasma display, etc.) and a printer 18. Still further, the computer system 10 includes one or more input devices including, for example, a keyboard/mouse 20, a CD or DVD reading device 21, a magnetic storage device reader 22, etc. Of course, other types of data input devices, such as other memory access devices including smart card readers, RAM and ROM devices, etc. could be provided within the computer system 10 to enable the processor 12 to access data stored in any known or desired format. Still further, the computer system 10 may be connected via a modem, cable, or wireless connection to any desired local area network (LAN) or wide area network (WAN) including, for example, the Worldwide Web, the Internet, etc., to receive data from one or more remote sites.

As illustrated in FIG. 1, the memory 14 includes databases 30-33 and programs 34-36 stored therein. As will be understood, the programs 34-36 described herein may be executed on the processor 12 at various times to store and manipulate data in the databases 30-33 as well as to determine a valuation for a particular vehicle using data stored in one or more of the databases 30-33. In particular, a comparison vehicle database 30 stores information or data pertaining to comparison vehicles to be used in performing valuations for any specific vehicle, such as an insured or claimant vehicle. This comparison vehicle data may be collected from any desired source, such as by the FIRs as described above, from newspaper advertisements, automobile periodicals, the Internet, etc. Additionally, as will be described in more detail hereinafter, the comparison vehicle database 30 may store actual sales price data for some or all of the comparison vehicles as collected from a government agency. Of course, this data may be collected in any desired manner and provided to the database 30 using any known or desired data transmission techniques.

A Standard vehicle description database 32 may store information pertaining to standard or typical options and equipment for vehicles of a particular year, make and model, average mileage for vehicles based on year, make and model, vehicle type, etc., the average condition of a vehicle based on the year, mileage or location of the vehicle, for any number of years or vehicles. The standard vehicle description database 32 may be used to fill in data or supplement data within the comparison vehicle database 30 when particular option, equipment, mileage, and condition data is not available, such as when the comparison vehicle data is collected from an advertisement or solely from a government agency. Still further, the standard vehicle description database 32 may store VINs (or other unique identifiers) for automobiles and any known information (such as options and equipment) about the automobile having that VIN. This information may be determined from or provided by automobile manufacturers, dealers, etc. and may be used to fill in data within the comparison vehicle database 30 if a VIN for the comparable vehicle is known and vehicle data for that VIN is stored in the database 32. Additionally or alternatively, actual vehicle information may be obtained directly from one or more automobile manufacturers identifying the type, model, make, color, engine, transmission, options, etc. associated with a unique automobile identifier, such as the VIN, of automobiles made by the one or more manufacturers, and this information may be stored in the database 32. Typically, this automobile information may be obtained from the manufacturers well before the automobiles are sold by dealers or private parties and therefore become eligible to be used as comparison vehicles. However, obtaining this automobile information from the manufacturers directly (or even indirectly through a third party) may reduce the amount of data that needs to be collected on a dealer lot or in an advertisement.

An adjustments database 33 stores information pertaining to the value or cost of numerous types of adjustments that are to be made to the value of one more of the comparable vehicles stored in the database 30 or to a vehicle for which a valuation is being determined based on the features, condition, mileage, etc. of those vehicles. The adjustments stored in the adjustments database 33 may be dollar amounts or may be equations used to determine dollar amount adjustments. These adjustments may be dependent on any desired factors such as type and style of automobile, etc. Additionally the adjustment amounts stored in the database 33 may change over time and may be determined in any typical or standard manner, such as by interviewing or polling automobile dealers.

Still further, a valuation application 34 stored in the memory 14 may be executed on the processor 12 to use the data within the comparison vehicle database 30 and, if necessary, the data stored in the standard vehicle description database 32 and the adjustments database 33, as well as data provided by a user, such as an insurance adjuster, regarding an insured or claimant vehicle, to produce one or more valuation reports as will be described in more detail herein, during the performance of a vehicle evaluation. A data input program 36 may be executed on the processor 12 to enable a user or a database manager to input data into one of the databases 30-33, or to delete, change or deactivate data stored in the databases 30-33. The data being placed into the databases 30-33 may include comparable vehicle data collected by, for example, FIRs or other data acquirers from dealer lots, from newspaper and periodical advertisements, etc. as well as from one or more government agencies and automobile manufacturers. This data may be provided to the computer system 10 via a remote connection, one of the data input devices 20-22 or via any other desired data delivery mechanism including a personal data assistant (PDA), a laptop or other portable computer, etc.

The data input program 36 may be run periodically or automatically to remove data from the comparison vehicle database 30 or to disable data within the comparison vehicle database 30 to prevent that data from being used by the valuation program 34 after that data becomes stale or out of date, such as when data stored within the database 30 has been stored or was collected more than, for example, 90 days prior. This data culling prevents data within the comparison vehicle database 30 from being used in the valuation program 34 after a certain period of time, which thereby keeps the data within the comparison vehicle database 30 fresh or up-to-date. Assuring that only recent data is used in valuations makes the ultimate valuation for a particular automobile more reflective of the current local market as it is well known that the value of an automobile changes over time.

While the databases 30-33 have been illustrated in FIG. 1 as being stored within the same memory as the programs 34 and 36, it will be understood that these databases may be implemented in different computer readable memories, such as in one or more different memories associated with the computer system 10 as well as one or more memories connected to the computer system 10 via any desired hardwired or wireless communication network. Furthermore, while the valuation and data input programs 34 and 36 have been illustrated as individual components adapted to be executed on a general purpose processor, those skilled in the art will understand that the partitioning of individual components is discretionary to those responsible for implementation of the computer system 10 and that these functions can be implemented in any desired manner. Likewise, any portions of the programs 34 and 36 may be implemented in hardware, firmware, etc., and may be implemented by any other type of processor associated with the computer system 10. Thus, the elements described herein may be implemented in a standard multi-purpose CPU or on specifically designed hardware or firmware such as an application-specific integrated circuit (ASIC) or other hard-wired device as desired. When implemented in software, the software routines may be stored in any computer readable memory such as on a magnetic disk, a laser disk (such as a CD, a DVD, etc.), a smart card or other storage medium, in a RAM or ROM of a computer or processor, in any database, etc. Likewise, this software may be delivered to a user via any known or desired delivery method including, for example, on a computer readable optical or magnetic disk or tape, smart card memories, or other transportable computer storage mechanisms or over a communication channel such as a telephone line, the Internet, etc. (which are viewed as being the same as or interchangeable with providing such software via a transportable storage medium).

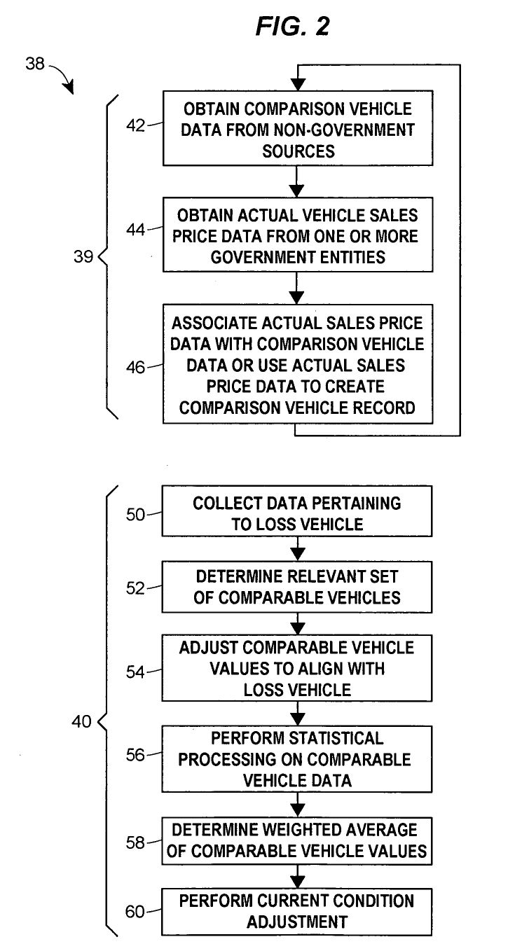

FIG. 2 illustrates a flow chart 38 of a method or procedure of obtaining and using actual vehicle sales price data to create a vehicle valuation. As will be understood, the flow chart 38 is divided into two general sections 39 and 40 which can be performed and repeated independently of one another. The first section 39 is associated with collecting and preprocessing comparison vehicle data to be used at a later time in performing vehicle valuations while the second section 40 is associated with performing a vehicle valuation for a particular vehicle, such as an insured or claimant vehicle, using the comparison vehicle data currently stored in the comparison vehicle database 30.

At a block 42, data pertaining to one or more comparison vehicles may be obtained from non-government sources, for example, dealer lots, advertisements, brochures, the internet, etc. As in the past, FIRs may physically go to automobile dealer lots, inspect the vehicles for sale and collect pertinent data from those automobiles meeting Dealer Ready quality standards pertaining to those vehicles. For example, the FIRs may obtain vehicle identification numbers (VINs), year, make and model information, options and equipment information (such as the existence of air conditioning, type of transmission, existence and type of stereo equipment, the type or size of the engine, the existence of a sunroof, etc.), mileage, and general condition information for numerous automobiles on the dealer lots. As part of this information, a designation of the local geographic region or market in which the dealer lot is located may be obtained through mapping the address of the lot to a region table using the zip code of the dealer lot. Of course, if desired, a dealer identity number may be used to indicate the geographic region or market in which the dealer is located. If desired, the database 32 of FIG. 1 may store an association between a geographic region and a dealer identification number. While the FIRs may obtain dealer list price information and dealer take price information, in at least one embodiment, the FIRs may not need to collect this information as it may be supplanted by actual sales price information collected at a later date. Additionally, some of the automobile description information may be colleted from the automobile manufacturers and stored in the database 32 prior to the FIRs visiting the dealer lots.

In any event, the collected data may be supplied to and entered into the database 30 of FIG. 1 in any desired manner. For example, the data may be collected on paper and manually entered into the database 30 using the input/output program 36 or may be collected and stored on a computer, such as a laptop computer, a personal data assistant (PDA), or any other electronic means and provided via a transportable memory, such as a CD, a DVD, a magnetic disk, a smart card, etc. to the computer system 10 of FIG. 1. Alternatively, if desired, this data may be stored in a remote database and may be accessed by the computer system 10 or sent to the computer system 10 of FIG. 1 via a local area network or a wide area network, such as the Internet, the World Wide Web, etc.

If desired, at the block 42, comparison vehicle data from other sources, such as newspaper and journal advertisements, specialized periodicals, the Internet, etc., may be collected and stored in the database 30 of FIG. 1, as is typically performed today.

Next, at a block 44, actual sales price data for vehicles is collected or obtained from a government agency, such as the DMV, the DOR, the IRS, etc. The government agency may be any government entity or agency that collects vehicle sales price data from automobile dealers, private parties (or other automobile sellers if so desired). Likewise, the government agency can be any of a local, a state or a federal government agency. Thus, for example, actual sales price data may be obtained from one or more of a state's DMV, from a state's department of revenue, from the federal IRS, from a local taxing agency, or from any other local, state or federal agency that collects vehicle sales price data in any form.

Of course, the actual manner of obtaining actual vehicle sales price data from a government agency may vary or differ based on the agency that collects that data. Thus, for example, it may be necessary to fill out appropriate forms or requests for the data from the government agency, or to take other steps mandated by a particular government agency to obtain the data. The data may need to be manually collected on a periodic or semi-periodic basis or, once the appropriate access is granted, may be collected automatically from the government agency. Thus, for example, it may be possible to have the appropriate government agency automatically and periodically send the collected vehicle sales price data to the computer system 10 of FIG. 1 either via a paper printout or in some convenient electronic format. In particular, the government agency may be set up to provide the data electronically, such as via a magnetic recordable medium (e.g., a magnetic tape or disk), an optical recordable medium (such as a CD, a DVD, etc.) or other transportable memory (computer readable medium) such as a smart card, or to send the data via an electronic data connection, such as the Internet, a telephone connection, a LAN, etc. If so, the sales price data, along with any other information or data related to the sales price data, may be provided in electronic format to the computer system 10. Alternatively, if the government agency provides the vehicle sales price data (and related vehicle information) in a paper or hard copy format, the vehicle sales price data may be entered into the computer system 10 manually via the keyboard 20 (and associated mouse), or may be scanned into an electronic format using any desired or known scanning technique and provided to the computer system 10.

Typically, the sales price data collected from the government agency will include some vehicle identification information, such as a VIN, the year, model and make of the vehicle, the mileage or approximate mileage, the date of the sale, a zip code associated with the dealer or private party or other identification information for the dealer or private party that made the sale, along with an exact or an approximate sales price. Thus, the government agency may not collect an exact sales price, but may collect or store an approximate sales price rounded to, for example, the nearest 500 dollars. It is considered, however, that vehicle sales price data that is not exact, but that has been rounded or provided within a certain tolerance, is still actual vehicle sales price data as used herein. Of course, the sales price data and other vehicle information or description data may vary in form and type depending on the identity of the government agency and the state in which this agency is located. Thus, in some cases, enough vehicle information may be collected from the government agency, along with the sales price for a vehicle, that comparison vehicle data need not be collected from the dealer lots as described above with respect to block 42. Thus for example, if the government agency provides a VIN along with a sales price and a geographic region for a sale, some detailed information about the vehicle may be obtained based on the provided VIN, and possibly supplemented by data collected from the automobile manufacturer based on that VIN. In particular, it is typically possible to obtain or infer the year, model and make of an automobile based on the VIN, and to then determine an average mileage for that vehicle, and the standard options, packages or equipment on the vehicle based on the vehicle designation information, the general condition of the vehicle, etc. If desired, such VIN data may be stored in the standard vehicle description database 32. Of course, inferring this information from the VIN may provide less detailed information about comparable vehicles than information that is collected independently of the sales price data, such as data collected by FIRs who inspect the vehicles on a dealer lot prior to the sale of the vehicles or data collected from automobile manufacturers based on, for example, VINs. Of course, it will be understood that vehicle data collected from automobile manufacturers may be collected well before (and possibly years before) that data is needed or before that data can be married up to comparable vehicle sales prices. As a result, the data collected from automobile manufacturers may need to be stored a relatively long period of time within the database 32.

Once vehicle sales price data is obtained from the appropriate government agency and is provided to the computer system 10, this data may be stored within the database 30. At a block 46, the vehicle sales price data collected from the government entity may be coordinated or associated with previously collected vehicle data, if any exists. In particular, if dealer vehicle data has been previously collected for a number of vehicles from dealer lots, and the sales price data is later received from the government agency for the same vehicles (evidencing a sale of those vehicles by the dealer and a subsequent reporting of those sales by the dealer to the government agency), then the sales price data from the government agency can be associated with the previously collected vehicle data stored in the database 30 using, for example, the VIN of the vehicle. In this manner, detailed information about a vehicle (including the VIN, condition information, mileage, options, equipment, etc.) may be collected at one time, such as when the vehicle is sitting on a dealer lot, and may be stored in the database 30 until after the dealer sells the vehicle. After the sale and reporting of the vehicle sale, the sales price data can be married or matched to the detailed information about the vehicle based on the VIN or any other unique identification information that is collected both at the dealer lot and along with the sales price data from the government agency. Of course, if desired, more than one market indication can be stored for any particular vehicle, including an actual sales price, a take price, an advertised price (which includes a sticker price), etc., and these different indications of market value may be used for different purposes when determining a valuation for a particular vehicle (e.g., the loss vehicle). After the sales price data obtained from the government agency has been associated with the detailed vehicle information (regardless of where the detailed vehicle information came from), the vehicle data can be stored in the database 30 as a comparison vehicle to be used in determining valuations for insured or claimant or loss vehicles.

Additionally or alternatively, however, the vehicle sales price data obtained from the government agency may be used to create new comparable vehicles within the database 30. In particular, the government agency may provide enough information about a vehicle which has been sold, such as a VIN, year, make and model, etc. to create a new comparison vehicle within the database 30. If desired, the data from the government agency may be used to obtain the basic description of the vehicle (such as the year, model and make) and typical or standard features of the comparable vehicle may be obtained from the standard vehicle database 32 based on this basic description.

As noted above, the steps 42-44 are associated with collecting comparison vehicle data to be stored in the database 32 and to be used during vehicle valuations. As a result, the steps 42-44 can be repeated as often as is desired or deemed necessary and may be completed in any desired order. In fact, the data collection and processing steps 42-44 can be constantly performed or repeated independently of steps that determine a vehicle valuation for an actual vehicle, as described in more detail below.

As will be understood, after detailed vehicle information including actual vehicle sales price data has been collected and stored in the database 30, this data may be used to perform vehicle valuations for actual vehicles. These valuation steps are generally indicated by the section 40 of the flowchart 38 which, in one case, may be performed by or using the valuation program 34 of FIG. 1. In particular, the vehicle valuation section 40 includes a block or a step 50 that collects data pertaining to the vehicle for which a valuation is to be performed. For the sake of convenience, this vehicle will be referred to herein as the loss vehicle or the insured or claimant vehicle, although this vehicle need not be a vehicle deemed to be a total loss nor a vehicle which is actually insured.

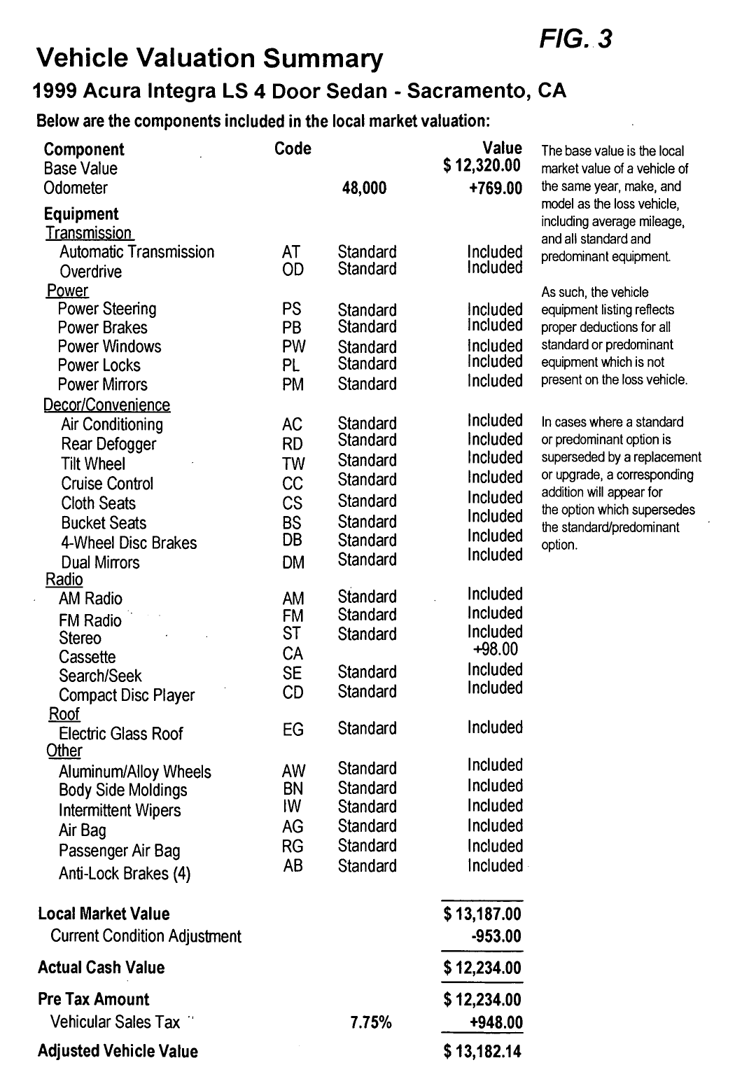

In any event, the loss vehicle data may be collected and provided by, for example, an insurance adjuster, a vehicle owner or any other user of the system 10 and may be entered into the computer system 10 and provided to the valuation program 34. Generally speaking, at the block or step 50, the valuation program 34 may create a report that generally lists the loss vehicle information as provided by or input by the user. An example of a vehicle valuation report having such information is illustrated in FIG. 3 for a 1999 Acura Integra LS 4 Door Sedan in Sacramento, Calif., which will be used in the example described herein as the loss vehicle. As can be seen, the report of FIG. 3 is a vehicle valuation summary that lists the options and equipment of the loss vehicle and indicates whether those options or equipment are standard or are upgrades. As will be noted, the loss vehicle data input into the valuation system or program 34 will generally include the same types of information or data collected for the comparable vehicles, such as the year, make and model of the loss vehicle, the mileage of the loss vehicle, the general condition of the loss vehicle, a geographic designation associated with the loss vehicle (such as a zip code, a town and state, etc.), option and equipment data for the loss vehicle, etc. The report of FIG. 3 also provides a valuation summary including a value for the standard version of the loss vehicle, and additions and subtractions based on differences between the loss vehicle and a standard or dealer ready vehicle of the same year make and model of the loss vehicle. The manner in which these additions and subtractions are determined will be described in more detail below.

After data pertaining to the loss vehicle is entered, a block 52 of FIG. 2 selects or determines appropriate comparison vehicles from the comparison vehicle database 30 for performing a valuation of the loss vehicle. Such comparison vehicles may generally be selected based on two important aspects of the loss vehicle, namely, the vehicle family (year, make and model) and the local geographic area or region in which the loss vehicle resides. Thus, the block 52 may first determine the local region associated with the loss vehicle based on, for example, a zip code associated with the loss vehicle. Next, the block 52 may determine the vehicle family. Typically, the vehicle family will be the same make and model (possibly including different versions or body styles of the same model) and the same or very close year. Thus, the years of the comparable vehicles may be limited to the same year as the loss vehicle or one or two years older or newer than the loss vehicle.

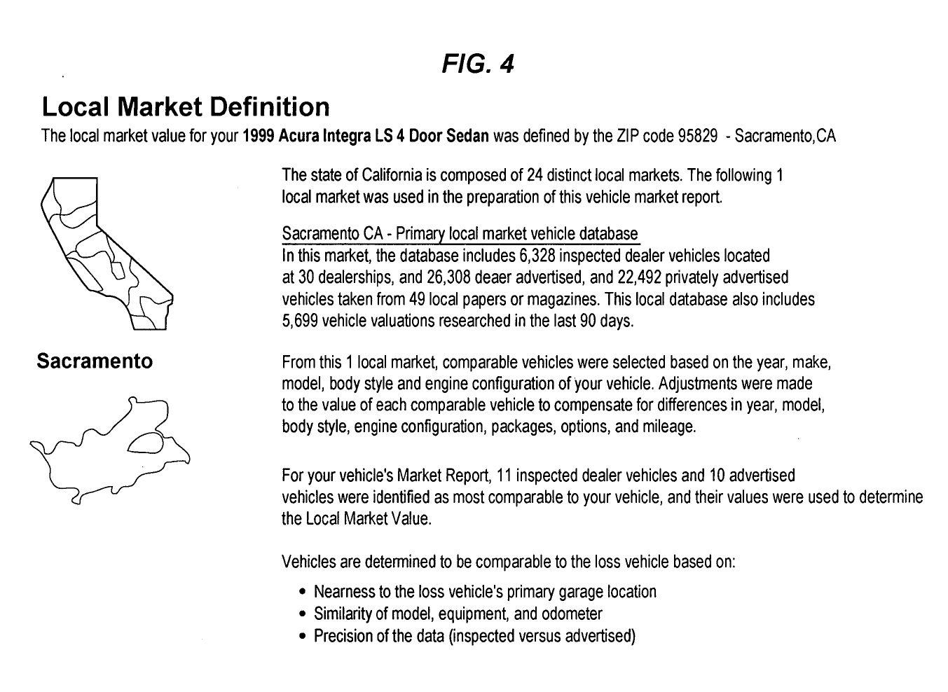

After the database 30 is searched based on the two criteria above, the block 50 has, in effect, identified a set of comparable vehicles for determining the value of the loss vehicle. These comparable vehicles may be inspected dealer vehicles, dealer advertised vehicles and/or privately advertised vehicles. FIG. 4 illustrates a report that may be generated by the block 52 or otherwise by the vehicle valuation program 34 of FIG. 1 defining the local market (based on the zip code of the loss vehicle) and the number and type of comparable vehicles for the 1999 Acura Integra LS 4 Door Sedan loss vehicle described in the report of FIG. 3. The report of FIG. 4 also indicates that adjustments were made to the comparable vehicles to compensate for differences in the year, model, body style, engine configuration, packages, options and mileage. As indicated in this example report, out of the 5,699 vehicle valuations researched in the last 90 days for the Sacramento, Calif. local region (all of which are stored in the database 30 of FIG. 1), 11 inspected vehicles and 10 advertised vehicles were found to be comparable to the loss vehicle based on the family definition of the loss vehicle.

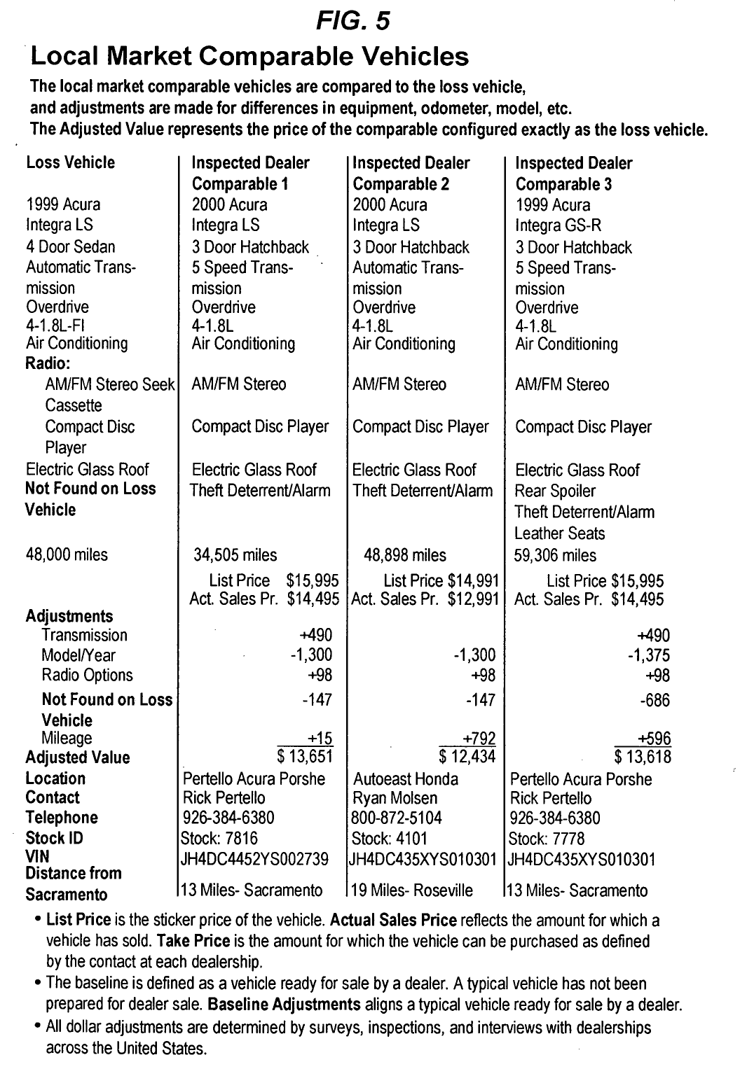

Next, a block 54 adjusts the value of each of the selected comparable vehicles identified by the block 52 to compensate for differences between each of the selected comparable vehicles and the loss vehicle. FIG. 5 illustrates a report showing a comparison of the loss vehicle to three dealer inspected comparable vehicles located in the search by the block 52. In particular, the first column of FIG. 5 represents or identifies the loss vehicle while each of the second, third and fourth columns of FIG. 5 represents one of the selected dealer inspected comparable vehicles. As will be noted, the top half of each column defines the pertinent parameters or features of the loss and comparable vehicles. Here, it will be noted that slight differences exist between the loss vehicle and each of the comparable vehicles. Thus, while still within the same family definition, the comparable vehicles may have different body styles or types, different transmissions, different engines, different options and stereo equipment, etc.

The second portion of each of the columns of FIG. 5 illustrates the adjustments made to the comparison vehicles by the block 54 to account for differences between a particular comparison vehicle and the loss vehicle. These adjustments may be made to increase or decrease the value of the comparison vehicle based on whether the loss vehicle includes a feature or is more desirable in some manner (such as having a lower mileage) than the comparison vehicle or whether the comparison vehicle has a feature or is more desirable in some manner than the loss vehicle. As illustrated in the example of FIG. 5, comparison vehicles may be increased in value to account for the benefit of the loss vehicle having an automatic transmission as compared to a manual transmission (comparison vehicles 1 and 3), decreased in value to account for the detriment of the loss vehicle being a year older than the comparison vehicle (comparison vehicles 1 and 2) or the loss vehicle being a less desirable body type (LS instead of a GS-R for comparison vehicle 3), increased in value to account for the loss vehicle having a better stereo system than the comparison vehicles, decreased in value to account for options or equipment on the comparison vehicle that are not present on the loss vehicle (e.g., an alarm system for comparison vehicles 1-3 and a rear spoiler and leather seats on comparison vehicle 3). Still further, adjustments may be made to based on the difference in mileage between the comparison vehicles and the loss vehicle. Of course, other adjustments besides those listed in the report of FIG. 5 may be made as well or instead.

It will be understood that a formula for or the actual dollar amounts of each of the adjustments may be stored in the adjustment database 33 of FIG. 1 and may be determined or set in any desired or appropriate manner. If desired, these adjustment values may be based on surveys, interviews with dealers and inspections of automobiles. However, these adjustments may be set and determined in other manners if so desired. Still further, these adjustment values may be used to adjust the most accurate base valuation of a comparable vehicle. Thus, in cases in which an actual sales price has been obtained for a comparable vehicle, the adjustments may be made to or from the actual sales price. This is the case for comparable vehicles 1 and 2 of FIG. 5. Alternatively, if no actual sales price has been obtained for a comparable vehicle, then the adjustments may be made to the list (advertised) price or to the take price if one has been determined. In the example of FIG. 5, the adjustments for the comparable vehicle 3 were made to the take price of the vehicle as no actual sale price was determined. Of course, where take prices are not allowed to be used, the adjustments may be made to the list or to the sticker price.

As also illustrated in FIG. 5, information about the dealer or private party which sold or which had the comparable vehicle on its lot may be provided in the report for verification purposes. Thus, the dealer name, contact, telephone number, and stock ID may be provided, as well as the VIN number for the comparable vehicle. Additionally, the date that the comparable vehicle was inspected or sold may be listed as well as the distance from the comparable vehicle to the loss vehicle based on, for example, the zip codes of the loss vehicle and the dealer.

It will be understood that the block 54 may perform a similar adjustment to each of the comparable vehicles whether the comparable vehicles are dealer vehicles for which actual sales prices have been obtained, dealer vehicles for which no actual sales price data has been obtained, private vehicles for which actual sales prices have been obtained or advertised vehicles (such as vehicles advertised in a newspaper, specialized periodical, etc.) for which no actual sales price data has been obtained. In the cases in which actual sales price data has not been obtained, the comparable vehicles may be adjusted based on the advertised price or a take price if one can be determined. It will also be understood that, if desired, the block 54 may be set up to use only actual sales price data for comparable valuations. In particular, in some geographic regions or local markets, it may be possible to populate the comparable vehicle database 30 of FIG. 1 with only vehicles for which actual sales prices have been obtained from one or more government agencies. This situation may arise because the collection of dealer sales prices from a government agency may provide a more comprehensive listing of the used cars sold in a particular region than was previously possible by manually collecting data by visiting dealer lots. Thus, it may be possible, based on the number of dealers within a particular local region, to collect enough vehicle sales information from the government agency or to populate vehicle sales information collected from the government agency with typical or standard vehicle information (or VIN information) or with actual vehicle information obtained from vehicle manufacturers (based on, for example, VINs) to dispense with collecting comparison vehicle information from advertisements. On the other hand, if desired, the block 54 may use comparison vehicles having valuations based on a take price or a list or advertised price in addition to comparison vehicles having a valuation based on an actual sales price as collected from a government agency.

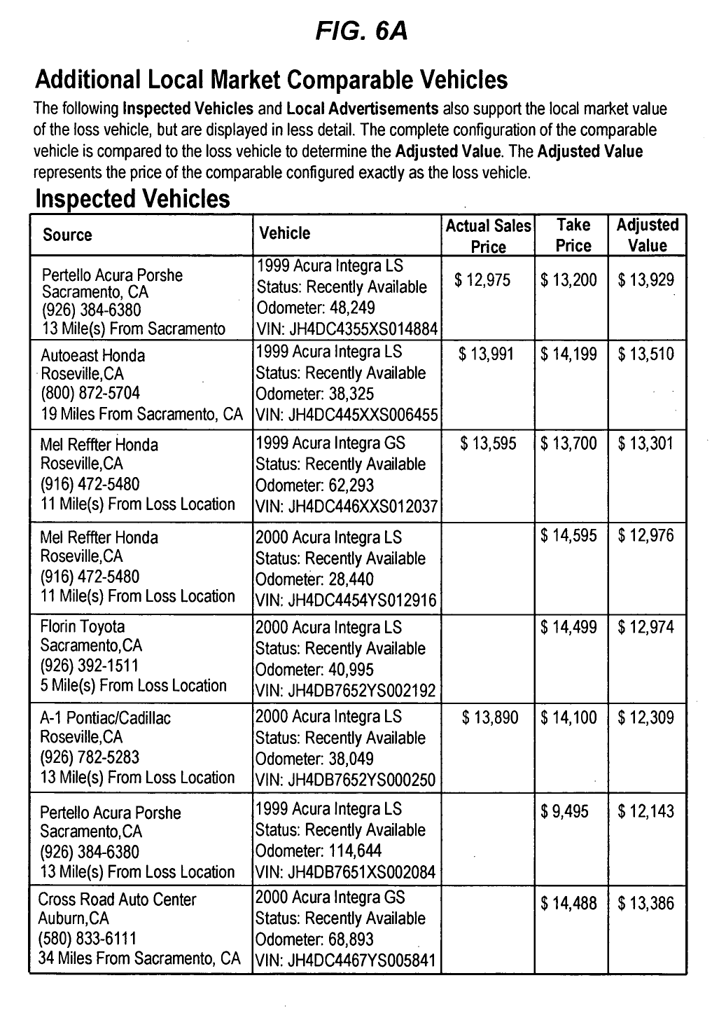

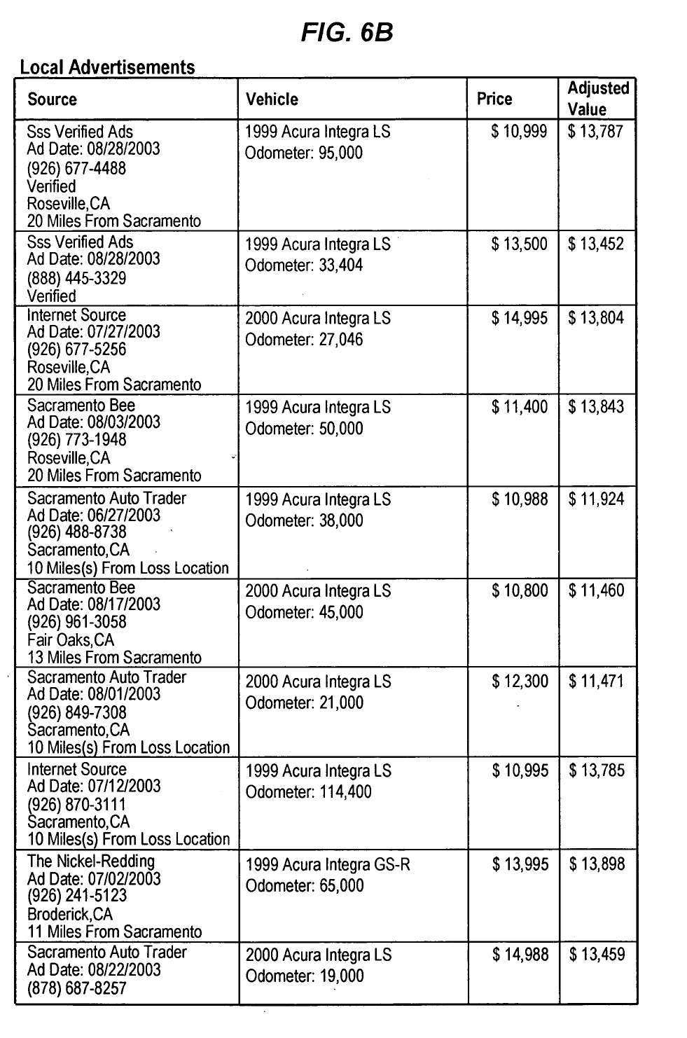

FIGS. 6A and 6B illustrate a report listing a summary of all of the other comparison vehicles identified by the block 52 as comparable vehicles for the 1999 Acura Integra LS loss vehicle. This report is divided into inspected vehicles (FIG. 6A) and advertised vehicles (FIG. 6B). For the inspected vehicles (i.e., ones in which FIRs actually viewed the vehicle) the report of FIG. 6A provides the identity of the source, the distance from the loss vehicle, specifics about the comparable vehicle, an actual sales price, if available, a take price and an adjusted value. For the advertised vehicles, the reports of FIG. 6B provides an identity of the source, an advertisement date, whether the advertisement was verified (such as by calling the seller to verify the data in the advertisement), the location of the advertised vehicle or the source, etc. Likewise, this report lists the pertinent features about the advertised vehicle as listed in the advertisement, such as the mileage, the year, make and model and body type, etc. Still further, the report of FIG. 6B lists the advertised or take price as well as an adjusted price. Of course, the adjusted prices of FIGS. 6A and 6B are developed in a manner similar to the manner described above with respect to the dealer inspected vehicles of FIG. 5. It will be understood that in the cases in which not all of the vehicle equipment, options, etc. were provided in an advertisement, that this data may be assumed or provided as appropriate from the standard feature database 32 of FIG. 1 or from a manufacturer based on VINs. Still further, for non-dealer vehicles, the comparable vehicles may be adjusted to place them in a dealer ready condition. In particular dealer automobiles typically meet higher quality standards.

Referring again to FIG. 2, a block 56 next performs some statistical analysis on the comparable vehicles to determine if a problem may exist with one or more of the comparable vehicles. For example, the block 56 may calculate a mean, a median and a standard deviation for all of adjusted values of the comparable vehicles. If a particular comparable vehicle falls outside some statistical measure, such as being more than two standard deviations above or below an average or a median, this comparable vehicle may be removed from the list or set used to actually determine a value for the loss vehicle. Of course, any desired statistical processing may be performed on the adjusted values (or other values) of the comparable vehicles and, generally speaking, this statistical processing is performed to eliminate outliers in the data set used to determine the value of the loss vehicle. Also, if desired, the presence of one or more comparable vehicles having an adjusted value that falls outside of some statistical measure may cause the valuation program 34 to notify a user, who can then manually review the set of comparable vehicles to establish the valuation.

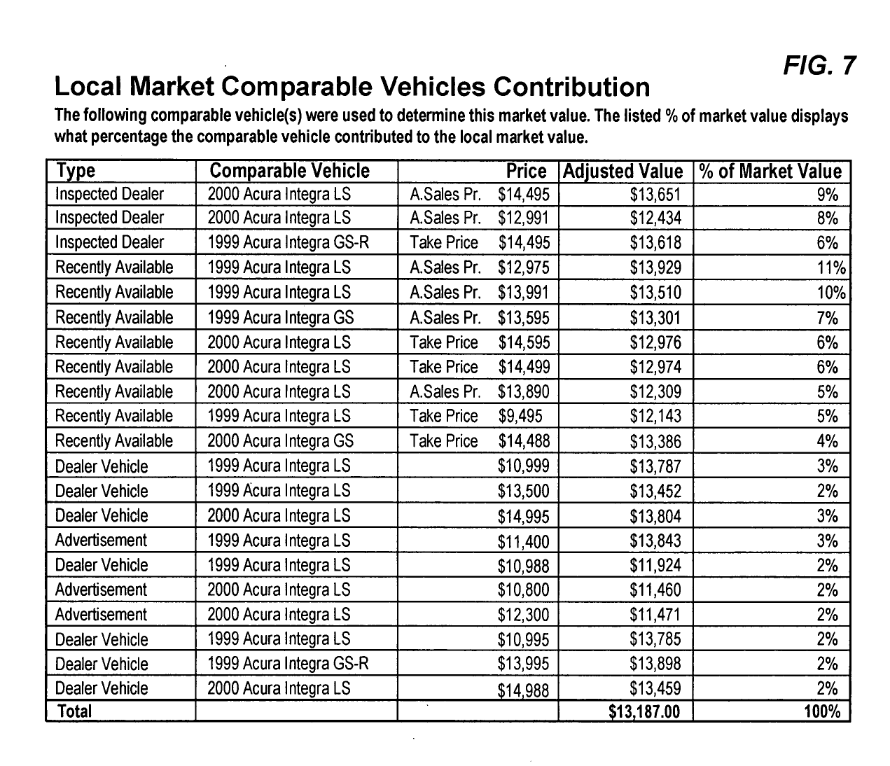

In any event, after the block 56 performs the statistical analysis to eliminate outliers within the set of comparable vehicles, a block 58 may determine a weighted or other average of the adjusted values of the remaining comparable vehicles to produce a valuation of the loss vehicle. The block 58 may print or provide a report such as that of FIG. 7 illustrating the comparable vehicles and adjusted values used in the average, along with the actual weight (as applicable) given to each of the comparable vehicles. The weight given to any particular comparable vehicle may be varied based on a number of factors, including for example, the geographical distance between the comparable vehicle and the loss vehicle (with the closer comparable vehicle typically receiving a higher weight) and the closeness in the year, make and model of the comparable vehicle and the loss vehicle (with different years, models and body types being given less weight than the same year, model and body type). Additionally, if desired, comparable vehicles having an adjusted value based on an actual sales price that has been obtained from, for example, a government agency or other verifiable source, may be provided or given more weight than a comparable vehicle having an adjusted value based on an advertised price, a list price or a take price.

Of course, other factors may be used as well to determine the particular weighting to be given to any particular comparison vehicle. In one embodiment, the weighting may generally be provided or use according to the manner set forth below, although other reasonable weighting schemes could be used as well or instead, and an arithmetic average may be used in the alternative as required by governmental entities.

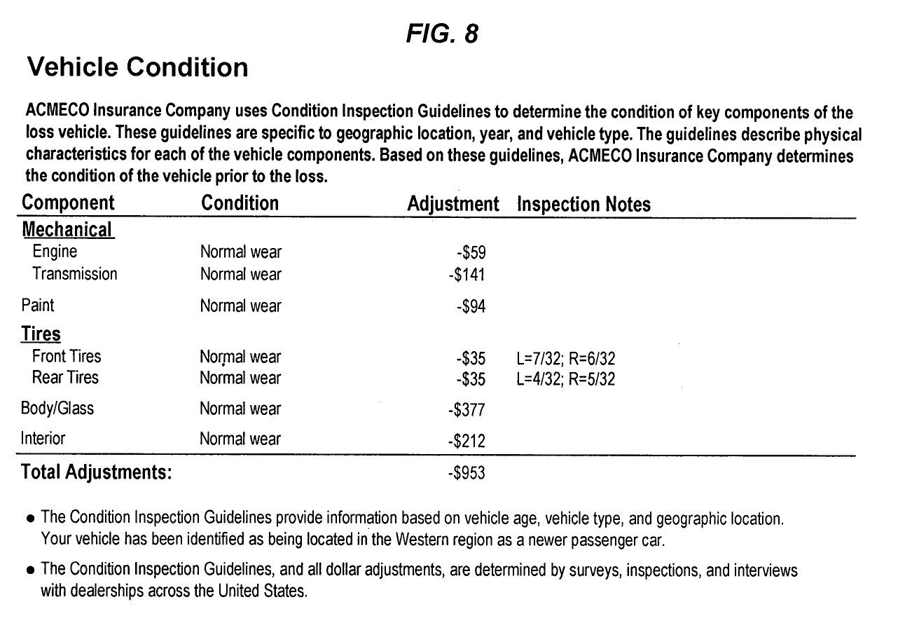

After the block 58 determines the weighted average of the comparable vehicles, this weighted average may be used as the local market value for a vehicle in the baseline condition designated by the customer. Thus, as illustrated in the report of FIG. 3, the Local Market Value of the loss vehicle is listed as the weighted average determined or illustrated in FIG. 7. However, because all of the comparable vehicles were adjusted to be in a dealer-ready or average-private condition (as specified by the customer), the loss vehicle also needs to be adjusted to the extent that it is not in dealer-ready condition (or average-private condition). This adjustment is identified in FIG. 3 as the Current Condition Adjustment. The current condition adjustment for the loss vehicle may be determined by a block 60 of FIG. 2 based on a physical inspection of the loss vehicle by, for example, the insurance adjuster. FIG. 8 illustrates a report that may be generated by the block 60 to define the current condition adjustments made to the loss vehicle to account for the differences between the condition of the loss vehicle (prior to the accident) and a dealer-ready version of that same vehicle, to which the values of all of the comparison vehicles were adjusted.

Thus, as illustrated in FIG. 8, deductions to the local market value of the loss vehicle are made based on the inspected condition of the loss vehicle. In this case, the loss vehicle had normal wear on the engine and transmission and paint, normal wear on the front and rear tires and on the body and glass. Deductions in the value of the loss vehicle were made in each of these categories as a dealer ready vehicle typically has less than normal wear or is in good condition. Of course, the current condition of the loss vehicle is based on a physical inspection of the vehicle. As a result, the inspection notes of the insurance adjuster or other inspector may be provided in the report of FIG. 8. The actual dollar amounts for the current condition adjustments may be determined in a manner similar to the adjustments made to the comparable vehicles and may be stored in the computer system 10 as a separate database or as part of the adjustment database 33. It will also be understood that other condition adjustments, besides those illustrated in FIG. 8 may be made to the loss vehicle in addition or instead of the condition adjustments illustrated in FIG. 8.

In any event, the current condition adjustments determined by the block 60 are then added to (or subtracted from) the vehicle value determined for the loss vehicle, as illustrated at the bottom of the report of FIG. 3. Still further, sales taxes and other applicable taxes and fees may be added to the value of the loss vehicle to determine a replacement amount or value of the loss vehicle. Of course, in a total loss situation, the insurance company may pay this amount or some lesser amount depending on the type of coverage, deductibles, etc. that the insured or claimant has on the insurance policy.

If desired, an entity, such as company, may keep and update the databases 30-33 and may operate by charging an amount, such as a fixed amount, for performing a valuation using the valuation program 34 for any particular loss vehicle. In this manner, the company may charge on a per use basis for running the valuation program 34. As part of this service, the program 34 may generate reports, such as the reports of FIGS. 3-8, and these reports may be sent in paper format, in electronic format or both to the person or entity paying for the service. However, if desired, the company may maintain the databases 30-33 and license the use of the program 34 in any other desired manner.

While one manner of producing a valuation for a vehicle based on actual vehicle sales prices data is described herein, other manners of determining a value for a vehicle based on actual sales price data may be used as well or instead of the system and method described herein. For example, vehicle valuations for comparable vehicles may be combined, such as averaged together, without these valuations being adjusted based on differences between these vehicles and the loss vehicle to produce an estimate of the valuation of the loss vehicle. In this case, the averaged value may be adjusted to account for differences between the loss vehicle and an “average” vehicle or a vehicle of average condition, options and equipment. Additionally, while the valuation based on data stored in a database for comparable vehicles is described herein as being performed on a computer, this valuation could be performed manually if so desired.

Thus, while the present invention has been described with reference to specific examples, which are intended to be illustrative only and not to be limiting of the invention, it will be apparent to those of ordinary skill in the art that changes, additions or deletions may be made to the disclosed embodiments without departing from the spirit and scope of the invention. It is also recognized that the specific approaches described herein represent but some of many possible embodiments of the invention described above. Consequently, the claims are properly construed to embrace all modifications, variations and improvements that fall within the true spirit and scope of the invention, as well as substantial equivalents thereof. Accordingly, other embodiments of the invention, although not described with particularly herein, are nonetheless considered to be within the scope of the invention.

1. A method of generating a vehicle valuation, comprising:
obtaining actual vehicle sales price data for a set of comparison vehicles from a government agency;
obtaining vehicle description data for one of the set of comparison vehicles;
obtaining vehicle description data for a particular vehicle; and
using the actual vehicle sales price data for the one of the set of comparison vehicles, the vehicle description data for the one of the set of comparison vehicles and the vehicle description data for the particular vehicle to determine a valuation for the particular vehicle.

2. The method of generating a vehicle valuation of claim 1, further including selling the valuation for the particular vehicle to a purchaser.

3. The method of generating a vehicle valuation of claim 2, wherein selling the valuation for the particular vehicle includes selling the valuation for the particular vehicle to an automobile insurance company.

4. The method of generating a vehicle valuation of claim 2, further including generating a report comparing the particular vehicle to the one of the set of comparison vehicles and providing the report to the purchaser.

5. The method of generating a vehicle valuation of claim 1, wherein obtaining vehicle description data for the particular vehicle includes obtaining the vehicle description data for the particular vehicle from the purchaser.

6. The method of generating a vehicle valuation of claim 1, wherein obtaining the vehicle description data for the one of the set of comparison vehicles includes obtaining a vehicle identification number for the one of the set of comparison vehicles.

7. The method of generating a vehicle valuation of claim 6, further including obtaining additional vehicle description data for the one of the set of comparison vehicles based on the vehicle identification number for the one of the set of comparison vehicles.

8. The method of generating a vehicle valuation of claim 1, wherein obtaining the vehicle description data for the one of the set of comparison vehicles includes estimating the vehicle description data for the one of the set of comparison vehicles based on standard features of a vehicle having two or more of the same year, make and model as the one of the set of comparison vehicles.

9. The method of generating a vehicle valuation of claim 1, wherein obtaining the vehicle description data for the one of the set of comparison vehicles includes visually inspecting the one of the set of comparison vehicles prior to obtaining the actual vehicle sales price data for the one of the set of comparison vehicles.

10. The method of generating a vehicle valuation of claim 1, wherein obtaining the vehicle description data for the one of the set of comparison vehicles includes obtaining the vehicle description data for the one of the set of comparison vehicles from the government agency along with the actual sales price data for the one of the set of comparison vehicles.

11. The method of generating a vehicle valuation of claim 1, wherein obtaining the vehicle description data for the one of the set of comparison vehicles includes obtaining the vehicle description data for the one of the set of comparison vehicles from a vehicle manufacturer for the one of the set of comparison vehicles.

12. The method of generating a vehicle valuation of claim 1, wherein obtaining actual vehicle sales price data for the set of comparison vehicles includes obtaining the actual vehicle sales prices data from a department of motor vehicles or a department of revenue.

13. The method of generating a vehicle valuation of claim 1, wherein obtaining actual vehicle sales price data for the set of comparison vehicles includes obtaining the actual vehicle sales prices data from a United States federal government agency.

14. The method of generating a vehicle valuation of claim 1, wherein obtaining actual vehicle sales price data for the set of comparison vehicles includes obtaining the actual vehicle sales prices data from a State government agency.

15. The method of generating a vehicle valuation of claim 1, wherein using the actual vehicle sales price data for the one of the set of comparison vehicles, the vehicle description data for the one of the set of comparison vehicles and the vehicle description data for the particular vehicle to determine a valuation for the particular vehicle includes comparing the vehicle description data for the particular vehicle to the vehicle description data for the one of the set of comparison vehicles and adjusting the actual vehicle sales price data for the one of the set of comparison vehicles to account for a difference in the vehicle description data for the particular vehicle and the vehicle description data for the one of the comparison vehicles.

16. The method of generating a vehicle valuation of claim 1, further including collecting vehicle description data for a second of the set of comparison vehicles from a non-government source and collecting a vehicle value indication for the second of the set of comparison vehicles from the non-government source and wherein using the actual vehicle sales price data for the one of the set of comparison vehicles, the vehicle description data for the one of the set of comparison vehicles and the vehicle description data for the particular vehicle to determine a valuation for the particular vehicle includes using the vehicle description data for the second of the set of comparison vehicles and the vehicle value indication for the second of the set of comparison vehicles to determine the valuation for the particular vehicle.

17. The method of generating a vehicle valuation of claim 16, wherein collecting a vehicle value indication for the second of the set of comparison vehicles includes collecting a take price for the second of the set of comparison vehicles.

18. The method of generating a vehicle valuation of claim 16, wherein collecting a vehicle value indication for the second of the set of comparison vehicles includes collecting an advertised price for the second of the set of comparison vehicles.

19. The method of generating a vehicle valuation of claim 16, wherein the non-government source is a published advertisement.

20. The method of generating a vehicle valuation of claim 16, wherein the non-government source is an automobile dealer.

21. The method of generating a vehicle valuation of claim 16, wherein using the actual vehicle sales price data for the one of the set of comparison vehicles, the vehicle, description data for the one of the set of comparison vehicles, the vehicle description data for the particular vehicle, the vehicle value indication for the second of the set of comparison vehicles and the vehicle description data for the second of the set of comparison vehicles includes computing an adjusted value for the one of the set of comparison vehicles based on the actual vehicle sales price data for the one of the set of comparison vehicles, computing an adjusted value for the second of the set of comparison vehicles based on the vehicle value indication for the second of the set of comparison vehicles, weighting the adjusted value for the one of the set of comparison vehicles and the adjusted value for the second of the set of comparison vehicles differently based on the vehicle description data for the one of the set of comparison vehicles and the vehicle description data for the second of the set of comparison vehicles and combining the weighted adjusted values for the one of the set of comparison vehicles and the second of the set of comparison vehicles to produce the valuation for the particular vehicle.

22. The method of generating a vehicle valuation of claim 21, wherein weighting the adjusted value for the one of the set of comparison vehicles and the adjusted value for the second of the set of comparison vehicles differently includes weighting the adjusted value for the one of the set of comparison vehicles and the adjusted value for the second of the set of comparison vehicles based on the geographical proximity of the one of the set of comparison vehicles and the second of the set of comparison vehicles to a location associated with the particular vehicle.

23. The method of generating a vehicle valuation of claim 21, wherein weighting the adjusted value for the one of the set of comparison vehicles and the adjusted value for the second of the set of comparison vehicles differently includes weighting the adjusted value for the one of the set of comparison vehicles higher than the adjusted value for the second of the set of comparison vehicles based on the vehicle valuation indication for the second of the set of comparison vehicles not being an actual vehicle sales price.

24. The method of generating a vehicle valuation of claim 21, wherein weighting the adjusted value for the one of the set of comparison vehicles and the adjusted value for the second of the set of comparison vehicles differently includes weighting the adjusted value for the one of the set of comparison vehicles and the adjusted value for the second of the set of comparison vehicles based on the similarity of a year, a make or a model of the one of the set of comparison vehicles and the second of the set of comparison vehicles to the particular vehicle.

25. The method of generating a vehicle valuation of claim 1, wherein obtaining vehicle description data for the one of the set of comparison vehicles includes obtaining a year, a make and a model identification for the one of the set of comparison vehicles.

26. The method of generating a vehicle valuation of claim 1, wherein obtaining vehicle description data for the one of the set of comparison vehicles includes obtaining an indication of a mileage associated with the one of the set of comparison vehicles.

27. The method of generating a vehicle valuation of claim 1, wherein obtaining vehicle description data for the one of the set of comparison vehicles includes obtaining an indication of a geographical location associated with the one of the set of comparison vehicles.

28. The method of generating a vehicle valuation of claim 1, wherein obtaining vehicle description data for the one of the set of comparison vehicles includes obtaining an indication of at least one of a type of transmission for the one of the set of comparison vehicles, an audio system associated with the one of the set of comparison vehicles, and a theft deterrent system associated with the one of the set of comparison vehicles.

29. The method of generating a vehicle valuation of claim 1, wherein obtaining actual vehicle sales price data for the set of comparison vehicles from a government agency includes obtaining actual vehicle sales price data relating to a commercial automobile dealer sale of one of the set of comparison vehicles.

30. The method of generating a vehicle valuation of claim 1, wherein obtaining actual vehicle sales price data for the set of comparison vehicles from a government agency includes obtaining actual vehicle sales price data relating to a private owner sale of one of the set of comparison vehicles.

31. The method of generating a vehicle valuation of claim 1, further including obtaining vehicle description data for a second of the set of comparable vehicles and collecting a vehicle value indication for the second of the set of comparison vehicles and wherein using the actual vehicle sales price data for the one of the set of comparison vehicles, the vehicle description data for the one of the set of comparison vehicles and the vehicle description data for the particular vehicle to determine a valuation for the particular vehicle includes combining the actual vehicle sales prices data for the one of the set of comparable vehicles and the vehicle value indication for the second of the set of comparable vehicles.

32. The method of generating a vehicle valuation of claim 31, wherein combining the actual vehicle sales price data for the one of the set of comparable vehicles and the vehicle value indication for the second of the set of comparable vehicles includes averaging the actual vehicle sales price data for the one of the set of comparable vehicles with the vehicle value indication for the second of the set of comparable vehicles.

33. A method of creating a vehicle valuation, comprising:
obtaining vehicle description data for each of a plurality of comparison vehicles;
obtaining an indication of a market value for each of the plurality of comparison vehicles, including obtaining actual vehicle sales price data for at least one of the plurality of comparison vehicles from a government agency as the indication of the market value for the at least one of the plurality of comparison vehicles;
storing the indications of the market value and the vehicle description data for each of the plurality of comparison vehicles in a database;
obtaining vehicle description data for a particular vehicle;
selecting a subset of the plurality of comparison vehicles based on similarities between the vehicle description data for the particular vehicle and the vehicle description data for each of the plurality of comparison vehicles; and
using the indications of the market values for the selected subset of the plurality of comparison vehicles, the vehicle description data for the selected subset of the plurality of comparison vehicles and the vehicle description data for the particular vehicle to determine a valuation for the particular vehicle.

34. The method of creating a vehicle valuation of claim 33, wherein selecting the subset of the plurality of comparison vehicles includes filtering the plurality of comparison vehicles based on similarities between two or more of a year, a make and a model of each of the plurality of comparison vehicles and the particular vehicle.

35. The method of creating a vehicle valuation of claim 33, wherein selecting the subset of the plurality of comparison vehicles includes filtering the plurality of comparison vehicles based on a location associated with each of the plurality of comparison vehicles and a location associated with the particular vehicle.

36. The method of creating a vehicle valuation of claim 33, wherein selecting the subset of the plurality of comparison vehicles includes filtering the comparison vehicles based on similarities between two or more of a year, a make and a model of each of the plurality of comparison vehicles and the particular vehicle and based on a location associated with each of the plurality of comparison vehicles and a location associated with the particular vehicle.

37. The method of creating a vehicle valuation of claim 33, including removing the vehicle description data for the at least one of the plurality of comparison vehicles as data to be used to select the subset of the plurality of comparison vehicles after a predetermined amount of time since the vehicle description data for the one of the plurality of comparison vehicles was obtained or was stored in the database.

38. The method of creating a vehicle valuation of claim 33, wherein obtaining an indication of a market value for each of the plurality of comparison vehicles includes obtaining an advertised price for a second of the plurality of comparison vehicles.

39. The method of creating a vehicle valuation of claim 33, wherein obtaining an indication of a market value for each of the plurality of comparison vehicles includes obtaining a take price for a second of the plurality of comparison vehicles.

40. The method of creating a vehicle valuation of claim 33, wherein obtaining vehicle description data for each of the plurality of comparison vehicles includes obtaining the vehicle description data for the at least one of the plurality of comparison vehicles from the government agency.

41. The method of creating a vehicle valuation of claim 33, wherein obtaining vehicle description data for each of the plurality of comparison vehicles includes obtaining the vehicle description data for the at least one of the plurality of comparison vehicles via a visual inspection of the at least one of the plurality of comparison vehicles.

42. The method of creating a vehicle valuation of claim 33, wherein obtaining the vehicle description data for each of the plurality of comparison vehicles includes obtaining the vehicle description data for one of the plurality of comparison vehicles from a vehicle manufacturer for the one of the plurality of comparison vehicles.

43. The method of creating a vehicle valuation of claim 33, further including selling the valuation for the particular vehicle to a purchaser.

44. The method of creating a vehicle valuation of claim 33, further including generating a report comparing the particular vehicle to each of the selected subset of the plurality of comparison vehicles.

45. The method of creating a vehicle valuation of claim 33, wherein obtaining the vehicle description data for each of the plurality of comparison vehicles includes obtaining a vehicle identification number for the at least one of the plurality of comparison vehicles.

46. The method of creating a vehicle valuation of claim 45, wherein obtaining vehicle description data for each of the plurality of comparison vehicles includes obtaining vehicle description data for the at least one of the plurality of comparison vehicles from the government agency.

47. The method of creating a vehicle valuation of claim 46, wherein obtaining vehicle description data for each of the plurality of comparison vehicles includes obtaining vehicle description data for the at least one of the plurality of comparison vehicles from the government agency contemporaneously with obtaining the actual vehicle sales price data for the at least one of the plurality of comparison vehicles from the government agency.

48. The method of creating a vehicle valuation of claim 33, wherein obtaining the vehicle description data for each of the plurality of comparison vehicles includes assuming the vehicle description data for the at least one of the plurality of comparison vehicles based on standard features of a vehicle having the same year, make or model as the at least one of the plurality of comparison vehicles.

49. The method of creating a vehicle valuation of claim 33, wherein obtaining the vehicle description data for each of the plurality of comparison vehicles includes visually inspecting the at least one of the plurality of comparison vehicles prior to obtaining the actual vehicle sales price data for the at least one of the plurality of comparison vehicles.

50. The method of creating a vehicle valuation of claim 33, wherein obtaining the actual vehicle sales price data for the at least one of the plurality of comparison vehicles includes obtaining the actual vehicle sales price data for the at least one of the plurality of comparison vehicles from a department of motor vehicles or a department of revenue.

51. The method of creating a vehicle valuation of claim 33, wherein using the indications of the market values for the selected subset of the plurality of comparison vehicles, the vehicle description data for the selected subset of the plurality of comparison vehicles and the vehicle description data for the particular vehicle to determine a valuation for the particular vehicle includes comparing the vehicle description data for the particular vehicle to the vehicle description data for each of the selected subset of the plurality of comparison vehicles and adjusting the indications of the market values for each of the selected subset of the plurality of comparison vehicles to account for one or more differences in the vehicle description data for the particular vehicle and the vehicle description data for each of the selected subset of the plurality of comparison vehicles.

52. The method of creating a vehicle valuation of claim 51, further including weighting the adjusted indications of the market values for two of the selected subset of the plurality of comparison vehicles differently based on differences in the geographical proximity of each of the two of the selected subset of the plurality of comparison vehicles and a geographical location associated with the particular vehicle.

53. The method of creating a vehicle valuation of claim 51, further including weighting the adjusted indications of the market values for two of the selected subset of the plurality of comparison vehicles differently based on differences in whether the indications of the market values for the two of the selected subset of the plurality of comparison vehicles comprises actual vehicle sales price data.

54. The method of creating a vehicle valuation of claim 51, further including weighting the adjusted indications of the market values for two of the selected subset of the plurality of comparison vehicles differently based on differences in a year, a make or a model of each of the two of the selected subset of the plurality of comparison vehicles and a year, a make or a model of the particular vehicle.

55. The method of creating a vehicle valuation of claim 33, wherein obtaining vehicle description data for each of the plurality of comparison vehicles includes collecting vehicle description data for a first set of the plurality of comparison vehicles from the government agency and collecting the vehicle description data for a second set of the plurality of comparison vehicles from a non-government source.

56. The method of creating a vehicle valuation of claim 55, wherein the non-government source is a published advertisement.

57. The method of creating a vehicle valuation of claim 55, wherein the non-government source is an automobile dealer.

58. The method of creating a vehicle valuation of claim 55, wherein the non-government source is an automobile manufacturer.

59. The method of creating a vehicle valuation of claim 33, wherein obtaining vehicle description data for the plurality of comparison vehicles includes obtaining an indication of a mileage associated with the at least one of the plurality of comparison vehicles.

60. The method of creating a vehicle valuation of claim 33, wherein obtaining the vehicle description data for the plurality of comparison vehicles includes obtaining an indication of a geographical location associated with the at least one of the plurality of comparison vehicles.

61. The method of creating a vehicle valuation of claim 33, wherein obtaining the vehicle description data for the one of the plurality of comparison vehicles includes obtaining an indication of at least one of a type of transmission for the one of the plurality of comparison vehicles, an audio system within the one of the plurality of comparison vehicles, and a theft deterrent system associated with the one of the plurality of comparison vehicles.

62. The method of creating a vehicle valuation of claim 33, wherein obtaining actual vehicle sales price data for at least one of the plurality of comparison vehicles from a government agency includes obtaining actual vehicle sales price data relating to a commercial automobile dealer sale of one of the plurality of comparison vehicles.

63. The method of creating a vehicle valuation of claim 33, wherein obtaining actual vehicle sales price data for at least one of the plurality of comparison vehicles from a government agency includes obtaining actual vehicle sales price data relating to a private owner sale of one of the plurality of comparison vehicles.

64. A system for use in producing a vehicle valuation report, comprising:
a computer readable medium;
a processor;
a database stored on the computer readable medium including vehicle description data for each of a plurality of comparison vehicles and an indication of a market value for each of the plurality of comparison vehicles, wherein two or more of the indications of a market value comprise actual vehicle sales price data;
an input routine stored in the computer readable medium and adapted be executed on the processor to accept vehicle description data for a particular vehicle;
a filtering routine stored in the computer readable medium and adapted to be executed on the processor to select a subset of the plurality of comparison vehicles based on similarities between the vehicle description data for the particular vehicle and the vehicle description data for the plurality of comparison vehicles stored in the database; and
a valuation routine stored in the computer readable medium and adapted to be executed on the processor to use the indications of the market value for the selected subset of the plurality of comparison vehicles, the vehicle description data for the selected subset of the plurality of comparison vehicles and the vehicle description data for the particular vehicle to determine a valuation for the particular vehicle.

65. The system of claim 64, wherein the indication of a market value for at least one additional comparison vehicle comprises an advertised price.

66. The system of claim 64, wherein the indication of a market value for at least one additional comparison vehicle comprises a take price.

67. The system of claim 64, wherein the indication of a market value for at least one additional comparison vehicle comprises an advertised price and the indication of a market value for a second additional comparison vehicle comprises a take price.

68. The system of claim 64, wherein the filtering routine is adapted to select the subset of the plurality of comparison vehicles based on similarities between two or more of a year, a make and a model of each of the plurality of comparison vehicles and the particular vehicle.

69. The system of claim 64, wherein the filtering routine is adapted to select the subset of the plurality of comparison vehicles based on distances between a location associated with each of the plurality of comparison vehicles and a location associated with the particular vehicle.

70. The system of claim 64, wherein the filtering routine is adapted to select the subset of the plurality of comparison vehicles based on similarities between a year, a make or a model of each of the plurality of comparison vehicles and the particular vehicle and based on distances between a location associated with each of the plurality of comparison vehicles and a location associated with the particular vehicle.

71. The system of claim 64, further including an additional routine adapted to remove the vehicle description data for one or more of the plurality of the comparison vehicles as data to be used by the filtering routine in selecting the subset of the plurality of comparison vehicles after a predetermined amount of time since the vehicle description data for the one or more of the plurality of comparison vehicles was obtained or was stored in the database.

72. The system of claim 64, further including a communication connection with a government entity, wherein the communication connection is adapted to provide the two or more indications of a market value comprising actual vehicle sales price data for the two or more associated comparison vehicles.

73. The system of claim 72, wherein the communication connection comprises an Internet communication connection.

74. The system of claim 72, wherein the communication connection comprises a transportable computer medium.

75. The system of claim 74, wherein the transportable computer medium comprises a magnetic recordable medium.

76. The system of claim 74, wherein the transportable computer medium comprises an optical recordable medium.

77. The system of claim 64, including a further database adapted to store general vehicle description data for one or more vehicles based on a combination of two or more of a year, a make and a model, and including a vehicle description routine stored on the computer readable medium and adapted to be executed on the processor to assign the general vehicle description data to one of the plurality of comparison vehicles based on the combination of two or more of a year, a make and a model of the one of the plurality of comparison vehicles.

78. The system of claim 64, further including a second database adapted to store vehicle description data for a first set of potential comparison vehicles without a market value indication indicative of an actual sales price for each of the first set of potential comparison vehicles, an input routine stored on the computer readable medium and adapted to be executed on the processor to accept data indicative of a market valuation in the form of actual vehicle sales price data along with a vehicle identity associated with each of a second set of potential comparison vehicles, and a matching routine stored on the computer readable medium and adapted to be executed on the processor to match the data indicative of a market valuation in the form of actual vehicle sales price data for at least one of the second set of potential comparison vehicles with the vehicle description data for at least one of first set of potential comparison vehicles based on the vehicle identity to create the vehicle description data and the indication of a market value for one of the plurality of comparison vehicles stored in the database.

79. The system of claim 64, further including a report generation routine stored on the computer readable medium and adapted to be executed on the processor to generate a report comparing the particular vehicle to each of the subset of the plurality of comparison vehicles.

80. The system of claim 64, further including a data handling routine stored on the computer readable medium and adapted to be executed on the processor to create the vehicle description data for one of the plurality of comparison vehicles based on standard features of a vehicle having the same year, the same make or the same model as the one of the plurality of comparison vehicles.

81. The system of claim 64, wherein the valuation routine is adapted to compare the vehicle description data for the particular vehicle to the vehicle description data for each of the selected subset of the plurality of comparison vehicles and to adjust each of the indications of the market value for the selected subset of the plurality of comparison vehicles to account for one or more differences in the vehicle description data for the particular vehicle and the vehicle description data for each of the selected subset of comparison vehicles.

82. The system of claim 81, wherein the valuation routine is adapted to weight the adjusted indications of the market values for two of the selected subset of the plurality of comparison vehicles differently based on differences in the geographical proximity of each of the two of the selected subset of the plurality of comparison vehicles and a geographical location associated with the particular vehicle.

83. The system of claim 81, wherein the valuation routine is adapted to weight the adjusted indications of the market values for two of the selected subset of the plurality of comparison vehicles differently based on whether or not the indications of the market values for the two of the selected subset of the plurality of comparison vehicles comprise actual vehicle sales price data.

84. The system of claim 81, wherein the valuation routine is adapted to weight the adjusted indications of the market values for two of the selected subset of the plurality of comparison vehicles differently based on one or more differences in a year, a make and a model of each of the two of the selected subset of the plurality of comparison vehicles and a year, a make and a model of the particular vehicle.

85. The system of claim 64, wherein the database is adapted to store vehicle description data for each of the plurality of comparison vehicles in the form of an indication of a mileage associated with each of the plurality of comparison vehicles.

86. The system of claim 64, wherein the database is adapted to store vehicle description data for each of the plurality of comparison vehicles in the form of an indication of a geographical location associated with each of the plurality of comparison vehicles.

87. The system of claim 64, wherein the database is adapted to store vehicle description data for each of the plurality of comparison vehicles in the form of an indication of at least one of a type of transmission for each of the plurality of comparison vehicles, an audio system associated with each of the plurality of comparison vehicles, and a theft deterrent system associated with each of the plurality of comparison vehicles.

88. The system of claim 64, wherein the database is adapted to store an additional market value indication for a first one of the comparison vehicles for which an indication of a market value comprising actual vehicle sales price data is stored.

89. The system of claim 88, wherein the additional market value indication comprises an advertised price.

90. The system of claim 88, wherein the additional market value indication comprises a take price.
